(19) United States
(12) Patent Application Publication
(10) Pub. No.: US 2019/0266638 A1
(43) Pub. Date: Aug. 29, 2019

(54) LANDMARK-BASED ADVERTISEMENT

(71) Applicant: INTERNATIONAL BUSINESS MACHINES CORPORATION, Armonk, NY (US)

(72) Inventors: Paul R. BASTIDE, Boxford, MA (US); Fang LU, Billerica, MA (US); Alaa Abou Mahmoud, Dracut, MA (US)

(21) Appl. No.: 15/905,181

(22) Filed: Feb. 26, 2018

(51) Int. Cl. G06Q 30/02

(52) U.S. Cl. CPC G06Q 30/0261; G06Q 30/0267; G06Q 30/0255

(57) ABSTRACT

According to one embodiment, a method, computer system, and computer program product for inserting advertisements into messages being exchanged between users based on geographical proximity is provided. The present invention may include identifying messaging programs on a user's mobile device; monitoring each message sent, received, or in the process of being typed between the user and one or more other users via the messaging programs for location references; receiving a location of the user, a location of other users, and a location of landmarks that are within a threshold distance of referenced locations indicated by the location references; selecting landmarks based on the user location, other user locations, and the landmark locations; and inserting a name for the selected landmarks into the messages containing the location references.

### BACKGROUND

The present invention relates, generally, to the field of computing, and more particularly to digital advertising.

Digital advertising is a field of marketing which leverages the reach and content of the internet, often in combination with the ubiquity and power of mobile phones, to deliver marketing messages to consumers. To the creative advertiser, the internet offers near-limitless opportunities to push brand awareness; common digital advertising methods include email marketing, search engine marketing, social media marketing, mobile advertising, and many types of display advertising. Display advertising comes in a variety of forms including web banners, which are graphical ads displayed within a web page; pop-up ads, which open above a website visitor's initial browser window; floating ads, which are ads that appear superimposed over the requested website's content; expanding ads, which change dimensions upon a predefined condition, such as a preset amount of time a visitor spends on a webpage, movement over the ad, etc.; and news feed ads, which typically exist on social media platforms that offer a steady stream of information updates. These ads may consist of video, audio, pictures and/or text, and serve to promote awareness of a brand or to increase a visitor's intention to buy a product or service. With access to the internet and access to mobile devices expanding to a massive portion of the world's population in recent years, digital advertising has become a massive revenue source for advertising agencies, webpage owners, and digital content creators alike.

### SUMMARY

According to one embodiment, a method, computer system, and computer program product for inserting advertisements into messages being exchanged between users based on geographical proximity is provided. The present invention may include identifying messaging programs on a user's mobile device; monitoring each message sent, received, or in the process of being typed between the user and one or more other users via the messaging programs for location references; receiving a location of the user, a location of other users, and a location of landmarks that are within a threshold distance of referenced locations indicated by the location references; selecting landmarks based on the user location, other user locations, and the landmark locations; and inserting a name for the selected landmarks into the messages containing the location references.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a landmark-based advertising process according to at least one embodiment;

FIG. 3 is a block diagram of internal and external components of computers and servers depicted in FIG. 1 according to at least one embodiment;

FIG. 4 depicts a cloud computing environment according to an embodiment of the present invention; and

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to digital advertising. The following described exemplary embodiments provide a system, method, and program product to, among other things, identify location references within the text communications of a user, and insert the names of relevant businesses at contextually appropriate points within those communications. Therefore, the present embodiment has the capacity to improve the technical field of digital advertising by providing a method of leveraging a user's current location and messaging programs to present advertisements in a method far less intrusive than conventional means of advertising, such as popups or banner ads, by presenting advertisements within the text of a conversation rather than in a separate application or popup; the present embodiment further presents advertisements in a fashion that is helpful to the user by predicting destinations or nearby locations and inserting businesses as landmarks into messages, thereby aiding the user by providing proximate landmarks to navigate by.

As previously described, digital advertising is a field of marketing which leverages the reach and content of the internet, often in combination with the ubiquity and power of mobile phones, to deliver marketing messages to consumers. To the creative advertiser, the internet offers near-limitless opportunities to push brand awareness; common digital advertising methods include email marketing, search engine marketing, social media marketing, mobile advertising, and many types of display advertising. Display advertising comes in a variety of forms including web banners, which are graphical ads displayed within a web page; pop-up ads, which open above a website visitor's initial browser window; floating ads, which are ads that appear superimposed over the requested website's content; expanding ads, which change dimensions upon a predefined condition, such as a preset amount of time a visitor spends on a webpage, movement over the ad, etc.; and news feed ads, which typically exist on social media platforms that offer a steady stream of information updates. These ads may consist of video, audio, pictures and/or text, and serve to promote awareness of a brand or to increase a visitor's intention to buy a product or service. With access to the internet and access to mobile devices expanding to a massive portion of the world's population in recent years, digital advertising has become a massive revenue source for advertising agencies, webpage owners, and digital content creators alike.

With the advent of the internet and internet-enabled mobile devices, new resources have become available to advertisers to leverage in pursuit of greater marketing efficacy; navigation applications and messaging applications have become standard fare on nearly every mobile device, potentially allowing advertisers to leverage location, navigation and instant messaging data in marketing solutions. However, the field has lagged in producing practical applications of such information resources that promote brand awareness while simultaneously helping a user navigate and coordinate with other users. As such, it may be advantageous to, among other things, implement a system that combines location data, navigation data, and messaging data to predict the location, destination, and route of a user by reference to proximate business, and insert the names of those businesses into user messages to non-intrusively promote brand awareness while aiding with navigation.

According to one embodiment, the invention is a method of monitoring social interactions made via messaging applications for location references that are close to landmarks, and replace the location references with landmark names if the owners of the landmarks are enrolled in an advertising service. As an example, users A, B, and C are meeting at the mall; User A texts to User B, “hey B, I'm waiting for you at the XYZ mall.” Here the invention recognizes the XYZ mall, obtains the location of User A, finds the business closest to User A that is enrolled in the advertising service and adds that to the message, to produce the following: “hey B, I'm waiting for you at the XYZ mall next to Joe's Diner.” In a further scenario, where User B still cannot find User A, User B texts “where exactly is Joe's Diner?” Here the invention recognizes the question regarding the location of Joe's Diner and suggests an answer based on other paying services: “Joe's Diner is in front of Quest Buy.” In a third scenario, User C may be late and User A and User B want to know where she is. User C may text “I'm at the corner of First and Main Street.” In this situation the invention might detect the location and replace it with “I'm at the corner of First and Main Street next to Michael's.” Lastly, User C may be trying to describe where a particular business is, and types “Joe's Diner is right in front of ______” The invention may detect the blank and suggest “Quest Buy and Burger Kong” as proximate landmarks.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to identify location references within the text communications of a user, and insert the names of relevant businesses at contextually appropriate points within those communications.

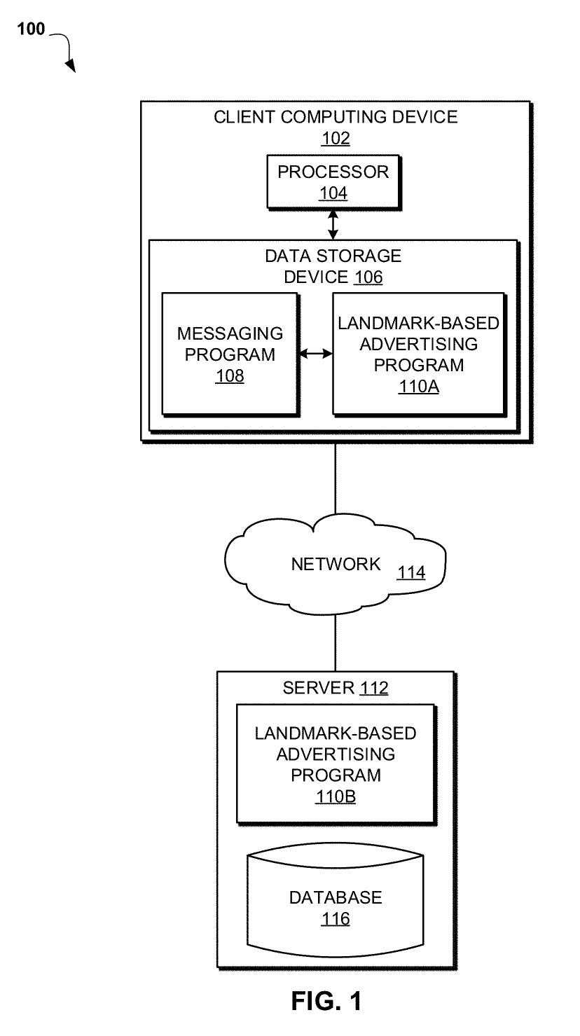

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

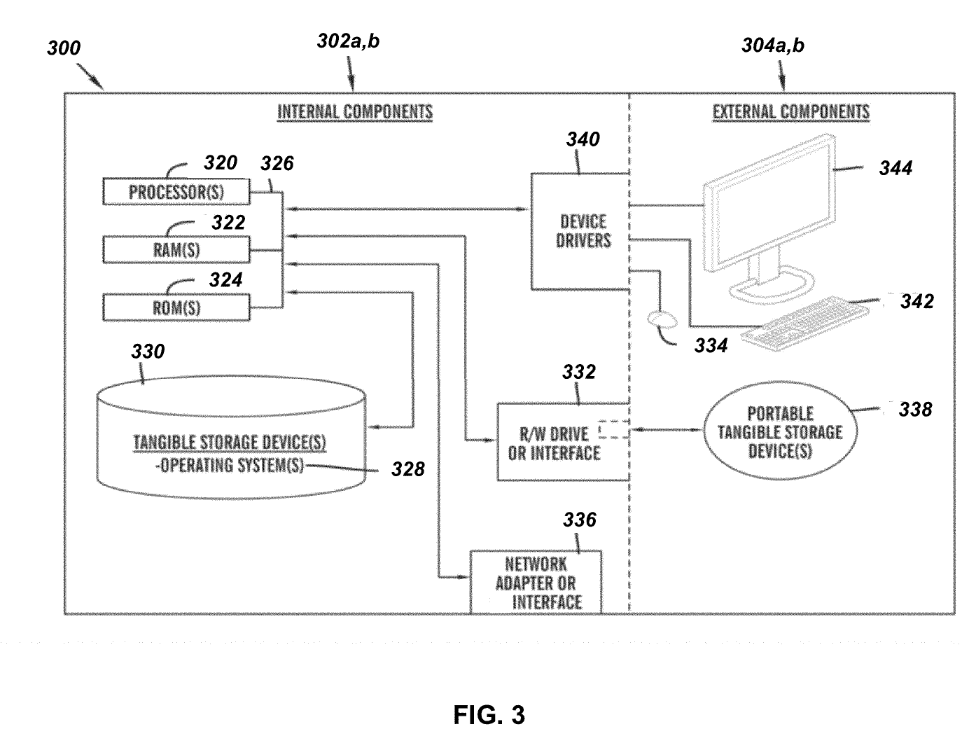

Client computing device 102 may include a processor 104 and a data storage device 106 that is enabled to host and run a messaging program 108 and a landmark-based advertising program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network and which may be transported by a user. As will be discussed with reference to FIG. 3, the client computing device 102 may include internal components 302a and external components 304a, respectively.

The server computer 112 may be a laptop computer, netbook computer, personal computer (PC), a desktop computer, or any programmable electronic device or any network of programmable electronic devices capable of hosting and running a landmark-based advertising program 110B and a database 116 and communicating with the client computing device 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

Messaging program 108 may be any program or service capable of communicating messages via text between devices. Exemplary programs may include Facebook® Messenger (Facebook® and all Facebook®-based trademarks and logos are trademarks or registered trademarks of Facebook, Inc. and/or its affiliates), WhatsApp® (WhatsApp® and all WhatsApp®-based trademarks and logos are trademarks or registered trademarks of WhatsApp Inc. and/or its affiliates), Twitter® (Twitter® and all Twitter®-based trademarks and logos are trademarks or registered trademarks of Twitter, Inc. and/or its affiliates), et cetera. Messaging program 108 need not necessarily be located on computing device 102; messaging program 108 may be located anywhere within communication of the landmark-based advertising program 110A, 110B, such as on computing device 102 or on any other device located within network 114. Furthermore, messaging program 108 may be distributed in its operation over multiple devices, such as multiple different computing devices 102.

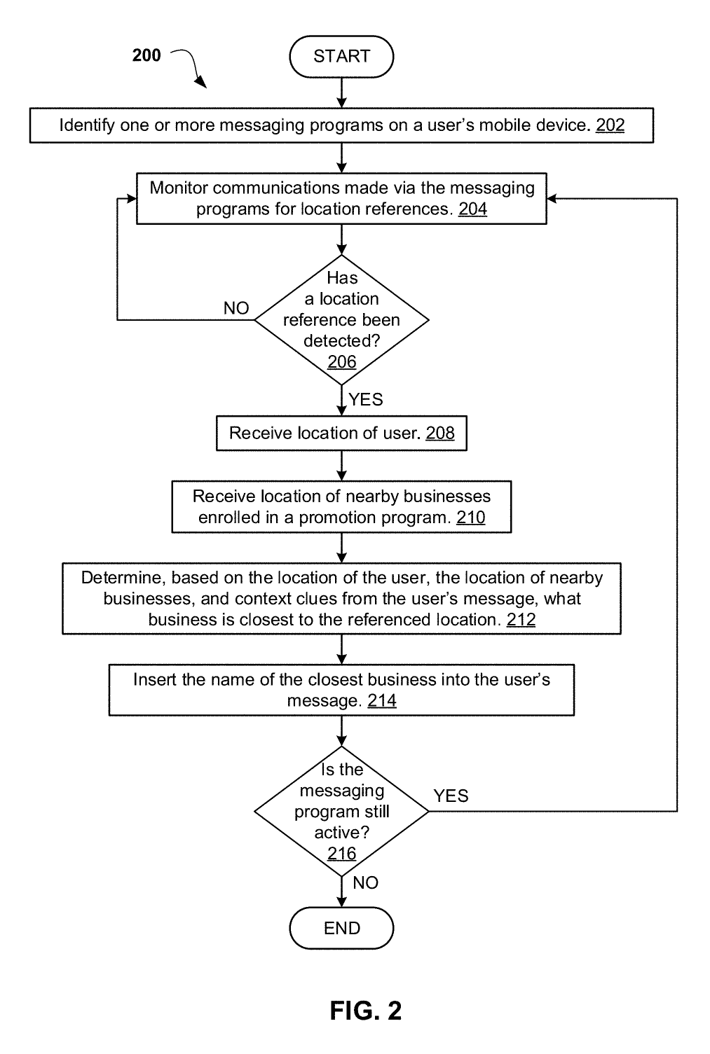

According to the present embodiment, the landmark-based advertising program 110A, 110B may be a program enabled to identify location references within the text communications of a user, and insert the names of relevant businesses at contextually appropriate points within those communications. The landmark-based advertising program 110A, 110B may be a standalone program, may be used in conjunction with one or more messaging programs 108, or may be an integrated component of one or more messaging programs 108. The landmark-based advertising program 110A, 110B may also be enabled to receive location data, either from a mobile device's integrated GPS, from a navigation app, from messaging program 108, or any other source in communication with landmark-based advertising program 110A, 110B. The landmark-based advertising program 110A, 110B may be located on computing device 102 or on any device located within network 114. Furthermore, landmark-based advertising program 110A, 110B may be distributed in its operation over multiple devices, such as multiple client computing devices 102. The landmark-based advertising method is explained in further detail below with respect to FIG. 2.

Referring now to FIG. 2, an operational flowchart illustrating a landmark-based advertising process 200 is depicted according to at least one embodiment. At 202, the landmark-based advertising program 110A, 110B identifies one or more messaging programs 108 on a user's mobile device. The landmark-based advertising program 110A, 110B may identify the one or more messaging programs 108 by searching the list of installed programs on the mobile device. In some embodiments, the landmark-based advertising program 110A, 110B may integrate automatically with all detected messaging programs 108. In other embodiments, landmark-based advertising program 110A, 110B may prompt the user to select which messaging programs landmark-based advertising program 110A, 110B may integrate with.

Next, at 204, landmark-based advertising program 110A, 110B monitors communications made via the messaging programs for location references. The landmark-based advertising program 110A, 110B may search all outgoing and incoming messages from the mobile device sent via any number of messaging programs 108 and process the language in each message using natural language processing methods to identify location references. Location references may be phrases that indicate a location directly or indirectly, which may vary by language but in English may include phrases such as “next to,” “in front of,” “around the corner of,” “down the street from,” et cetera. Location references may also be addresses, or landmark names.

Then, at 206, the landmark-based advertising program 110A, 110B determines whether a location reference has been detected. The landmark-based advertising program 110A, 110B detects a location reference by analyzing incoming and outgoing messages of one or more messaging programs 108 using natural language programming. According to one implementation, if the landmark-based advertising program 110A, 110B detects a location reference (step 206, “YES” branch), the landmark-based advertising program 110A, 110B may continue to step 208 to receive the location of the user. If the landmark-based advertising program 110A, 110B determines that no location reference has been detected (step 206, “NO” branch), the landmark-based advertising program 110A, 110B may continue to step 204 to continue monitoring communications made via the messaging programs for location references.

Next, at step 208, landmark-based advertising program 110A, 110B receives the location of the user. The landmark-based advertising program 110A, 110B may obtain the location of the user from the integrated GPS of a mobile device on which it is being run, or by integrating with a navigation program or any other program that has access to or gathers location data of the user. In some embodiments, landmark-based advertising program 110A, 110B may communicate its location to other mobile devices running landmark-based advertising program 110A, 110B, such that where two users each with landmark-based advertising program 110A, 110B installed on their mobile devices are separated by a significant distance, and User A sends a message to User B containing location references, landmark-based advertising program 110A, 110B on User B's mobile device may communicate its location to the landmark-based advertising program 110A, 110B on User A's mobile device, and vice versa.

Then, at step 210, landmark-based advertising program 110A, 110B receives the location of nearby businesses enrolled in a promotion program. In some embodiments of the invention, landmark-based advertising program 110A, 110B compiles or has access to a searchable database containing a list of all business subscribing to a promotion program, as well as the location of each business. The landmark-based advertising program 110A, 110B may search this database using the location of the user to produce a list of all businesses within a certain geographical threshold distance, which may be set by the user, pre-selected by landmark-based advertising program 110A, 110B, or dynamically selected by landmark-based advertising program 110A, 110B based on certain factors. In embodiments where the user is communicating with a distant second user, landmark-based advertising program 110A, 110B may receive business that are close to the distant second user with whom the first user is communicating. For example, a User A is communicating with a User B who is distant from User A, and both User A and User B have mobile devices currently hosting landmark-based advertising program 110A, 110B; the landmark-based advertising program 110A, 110B on User A's mobile device may receive a list of all businesses close to User B.

Next, at step 212, landmark-based advertising program 110A, 110B determines, based on the location of the user, the location of nearby businesses, and context clues from the user's message, what business is closest to the referenced location. The landmark-based advertising program 110A, 110B uses natural language processing to infer the location that the location reference is referring to, through various factors including context clues, the location of the user or users, the location of nearby businesses, et cetera. For instance, where a message says “let's meet at the eagle statue,” landmark-based advertising program 110A, 110B may infer from the location of the users that the eagle statue is relatively close to each user, and may therefore search for eagle statues in the general proximity of the users. The landmark-based advertising program 110A, 110B may further narrow the search, for instance, by prioritizing eagle statues that are between the users, or are in the same direction that one or more users are traveling. Once a likely eagle statue has been located, landmark-based advertising program 110A, 110B may then determine what businesses are closest to the relevant eagle statue.

Then, at step 214, landmark-based advertising program 110A, 110B inserts the name of the closest business into the user's message. The landmark-based advertising program 110A, 110B may insert the closest business into a message the user is typing, after the user has typed the message but before it has been sent. For example, if User A types “turn left at 4^{th} street,” to User B, and landmark-based advertising program 110A, 110B has determined Joe's Diner to be the closest business, landmark-based advertising program 110A, 110B may change the message to “turn left at 4^{th} street in front of Joe's Diner” after “turn left at 4^{th} street” has been typed out but before it has been sent. The landmark-based advertising program 110A, 110B may also merely prompt the user to insert the business name into the message. In other embodiments, landmark-based advertising program 110A, 110B may modify the message after it has been sent. The landmark-based advertising program 110A, 110B may also modify messages being received by the user, prior to the user seeing the text. In some embodiments, landmark-based advertising program 110A, 110B may insert proximate non-business landmarks, such as geographical features, salient structures such as fountains or statues, or other such points of interest into the message. In some embodiments, landmark-based advertising program 110A, 110B may not insert the closest business, but may insert businesses based on other factors or a combination of factors; these factors may include a businesses' popularity with the user, which might be determined by navigation data indicating that the user frequents a certain business more often, by a user's explicit preferences solicited via prompts or crawled from sources such as social media profiles, or by usage history of landmark-based advertising program 110A, 110B that for instance indicates that a user inserts a certain business name into messages often. In some embodiments, landmark-based advertising program 110A, 110B may insert business names or landmarks into empty spaces or when the user pauses in typing at a place where a business name would be contextually relevant based on location references.

Next, at step 216, landmark-based advertising program 110A, 110B determines whether the messaging program is still active. The landmark-based advertising program 110A, 110B may determine whether any of messaging programs 108 are still active by consulting the list of processes active on the processor of the mobile device. The landmark-based advertising program 110A, 110B may also determine whether any of the messaging programs 108 are still active by pinging or querying messaging programs and awaiting a reply; if a messaging program takes longer than a threshold interval to reply, the messaging program may be considered inactive. According to one implementation, if the landmark-based advertising program 110A, 110B detects that at least one messaging program is still active (step 216, “YES” branch), the landmark-based advertising program 110A, 110B may continue to step 204 to continue monitoring communications made via the messaging programs for location references. If the landmark-based advertising program 110A, 110B determines that no messaging programs are still active (step 216, “NO” branch), the landmark-based advertising program 110A, 110B may terminate.

It may be appreciated that FIG. 2 provides only an illustration of one implementation and does not imply any limitations with regard to how different embodiments may be implemented. Many modifications to the depicted environments may be made based on design and implementation requirements. While communications between two users are used in most of the examples herein presented, one skilled in the art would understand that the landmark-based advertising program 110A, 110B can be scaled to incorporate any number of users.

FIG. 3 is a block diagram 300 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302 a,b and external components 304 a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the messaging program 108 and the landmark-based advertising program 110A in the client computing device 102, and the landmark-based advertising program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the landmark-based advertising program 110A, 110B, can be stored on one or more of the respective portable computer-readable tangible storage devices 338, read via the respective R/W drive or interface 332, and loaded into the respective hard drive 330.

Each set of internal components 302 a,b also includes network adapters or interfaces 336 such as a TCP/IP adapter cards, wireless Wi-Fi interface cards, or 3G or 4G wireless interface cards or other wired or wireless communication links. The messaging program 108 and the landmark-based advertising program 110A in the client computing device 102 and the landmark-based advertising program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the messaging program 108 and the landmark-based advertising program 110A in the client computing device 102 and the landmark-based advertising program 110B in the server 112 are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

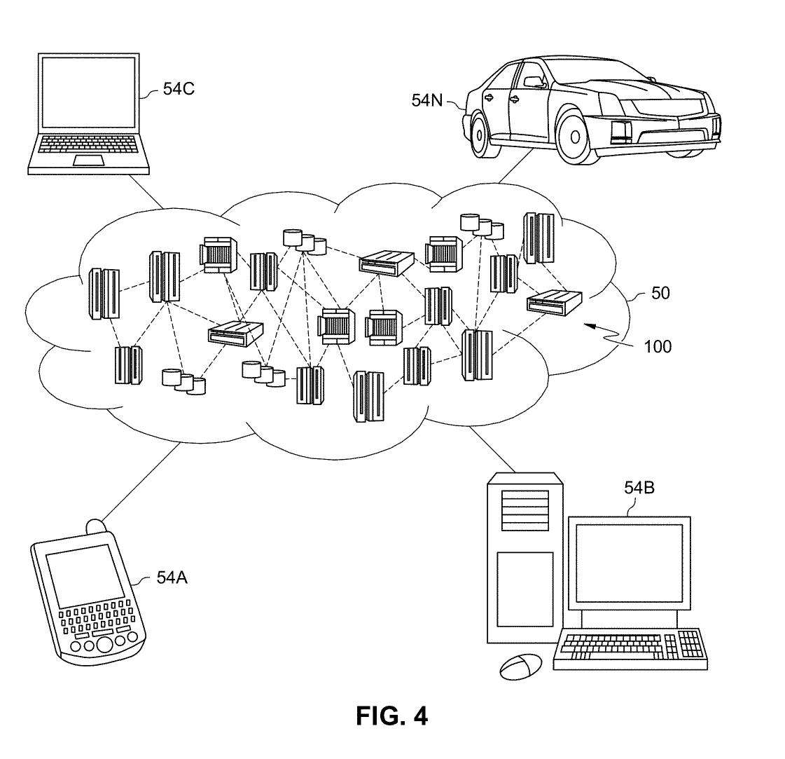

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

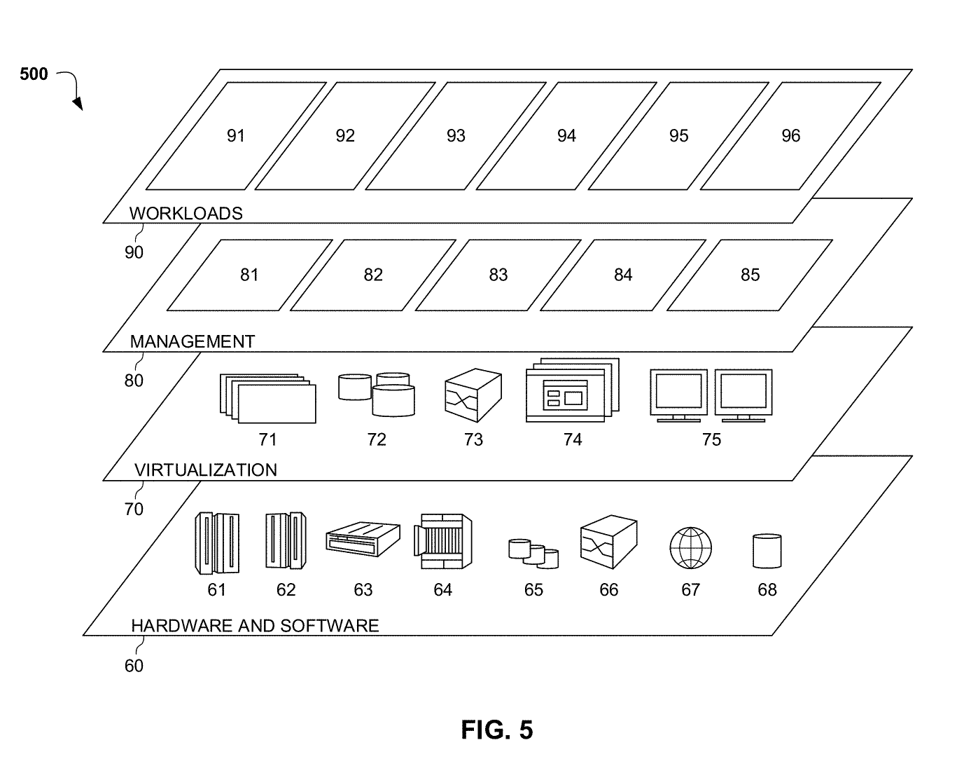

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and landmark-based advertising 96. landmark-based advertising 96 may relate to identify location references within the text communications of a user, and insert the names of relevant businesses at contextually appropriate points within those communications.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for inserting landmark-based advertising into messages on mobile devices, the method comprising:
identifying one or more messaging programs on a user's mobile device;
monitoring each message sent, received, or in the process of being typed between the user and one or more other users via the one or more messaging programs for one or more location references;
receiving a location of the user, a location of one or more other users, and a location of one or more landmarks that are within a threshold distance of one or more referenced locations indicated by the one or more location references;
selecting one or more landmarks based on the user location, one or more other user locations, and the one or more landmark locations; and
inserting a name for one or more of the selected landmarks into the one or more messages containing the one or more location references.

2. The method of claim 1, wherein the one or more landmarks comprise one or more businesses enrolled in a promotion service.

3. The method of claim 1, wherein the one or more selected landmarks are selected based on a threshold distance to the one or more locations indicated by the one or more location references.

4. The method of claim 1, wherein the one or more selected landmarks are selected based on a usage history or a navigation history of the one or more users.

5. The method of claim 1, wherein the one or more selected landmarks are selected based on one or more user preferences.

6. The method of claim 1, further comprising:
prompting the user to insert one or more selected landmarks in a message being typed that contains the one or more location references.

7. The method of claim 1, wherein the one or more landmarks comprise one or more geographical points of interest or one or more structural points of interest.

8. A computer system for inserting landmark-based advertising into messages on mobile devices, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying one or more messaging programs on a user's mobile device;
monitoring each message sent, received, or in the process of being typed between the user and one or more other users via the one or more messaging programs for one or more location references;
receiving a location of the user, a location of one or more other users, and a location of one or more landmarks that are within a threshold distance of one or more referenced locations indicated by the one or more location references;
selecting one or more landmarks based on the user location, one or more other user locations, and the one or more landmark locations; and
inserting a name for one or more of the selected landmarks into the one or more messages containing the one or more location references.

9. The computer system of claim 8, wherein the one or more landmarks comprise one or more businesses enrolled in a promotion service.

10. The computer system of claim 8, wherein the one or more selected landmarks are selected based on a threshold distance to the one or more locations indicated by the one or more location references.

11. The computer system of claim 8, wherein the one or more selected landmarks are selected based on a usage history or a navigation history of the one or more users.

12. The computer system of claim 8, wherein the one or more selected landmarks are selected based on one or more user preferences.

13. The computer system of claim 8, further comprising:
prompting the user to insert one or more selected landmarks in a message being typed that contains the one or more location references.

14. The computer system of claim 8, wherein the one or more landmarks comprise one or more geographical points of interest or one or more structural points of interest.

15. A computer program product for inserting landmark-based advertising into messages on mobile devices, the computer program product comprising:
one or more computer-readable tangible storage medium and program instructions stored on at least one of the one or more tangible storage medium, the program instructions executable by a processor to cause the processor to perform a method comprising:
identifying one or more messaging programs on a user's mobile device;
monitoring each message sent, received, or in the process of being typed between the user and one or more other users via the one or more messaging programs for one or more location references;
receiving a location of the user, a location of one or more other users, and a location of one or more landmarks that are within a threshold distance of one or more referenced locations indicated by the one or more location references;
selecting one or more landmarks based on the user location, one or more other user locations, and the one or more landmark locations; and
inserting a name for one or more of the selected landmarks into the one or more messages containing the one or more location references.

16. The computer program product of claim 15, wherein the one or more landmarks comprise one or more businesses enrolled in a promotion service.

17. The computer program product of claim 15, wherein the one or more selected landmarks are selected based on a threshold distance to the one or more locations indicated by the one or more location references.

18. The computer program product of claim 15, wherein the one or more selected landmarks are selected based on a usage history or a navigation history of the one or more users.

19. The computer program product of claim 15, wherein the one or more selected landmarks are selected based on one or more user preferences.

20. The computer program product of claim 15, further comprising:
prompting the user to insert one or more selected landmarks in a message being typed that contains the one or more location references.
